(19) United States
(12) Patent Application Publication
(10) Pub. No.: US 2026/0088918 A1
(43) Pub. Date: Mar. 26, 2026

(54) APPARATUS AND CORRESPONDING METHOD RELATING TO MAXIMUM SENSITIVITY DEGRADATION

(71) Applicant: Nokia Technologies OY, Espoo (FI)

(72) Inventors: Jan Torst HVIID, Klarup (DK); Vinayak BELLUR, Bangalore (IN); Kim NIELSEN, Storvorde (DK); Thomas Haaning JACOBSEN, Nørresundby (DK); Knud KNUDSEN, Aabybro (DK)

(73) Assignee: Nokia Technologies OY, Espoo (FI)

(21) Appl. No.: 19/331,288

(22) Filed: Sep. 17, 2025

(30) Foreign Application Priority Data
Sep. 26, 2024 (FI) 20246163

(51) Int. Cl. H04B 17/29; H04B 17/19; H04B 17/309

(52) U.S. Cl. CPC H04B 17/297; H04B 17/19; H04B 17/309

(57) ABSTRACT

Apparatus and a corresponding method are provided, the apparatus being configured to enter a test mode and determine a maximum sensitivity degradation, MSD, value for a multi-carrier communication mode supported by the apparatus, wherein the MSD value is determined according to a radiated performance test.

### FIELD OF THE INVENTION

Various example embodiments relate to apparatus and a corresponding method for the determination, of maximum sensitivity degradation (MSD) values.

### BACKGROUND TO THE INVENTION

Multi-carrier communication modes supported by user equipment (UE) include Carrier Aggregation (CA) and Dual connectivity (DC). Use of such multi-carrier communication modes can depend on the related capability of UE including a UE's MSD; that is, how a UE's own receiver is impacted by interference or noise from its own transmitter for a given communication mode.

### SUMMARY OF THE INVENTION

According to a first example embodiment, apparatus is provided configured to: enter a test mode; and determine a maximum sensitivity degradation, MSD, value for a multi-carrier communication mode supported by the apparatus, wherein the MSD value is determined according to a radiated performance test.

The MSD value may be determined when antenna(s) associated with the corresponding multi-carrier communication mode were in an active state during the test mode according to the radiated performance test.

The MSD value may be determined when a transmitter of the apparatus operates at a maximum output power in an environment isolated from any network, wherein the apparatus is in a state that is not configured or controlled by the network.

The MSD value may also be determined when a transmitter of the apparatus operates at maximum bandwidth.

The MSD value may be determined based on a measurement of a received signal strength indication, RSSI, value compared to a noise level.

Multiple MSD values for corresponding multi-carrier communication modes supported by the apparatus may be determined, including for different permutations of antenna configurations for otherwise the same multi-carrier communication mode.

Also, multiple MSD values may be determined for the same multi-carrier communication mode including one determined according to the radiated performance test and at least another not determined according to the radiated performance test.

The apparatus may be further configured to store the MSD value(s) in non-transient storage of the apparatus. Where this is the case, the apparatus may be further configured to select, using the stored MSD value(s), a multi-carrier communication mode or an antenna configuration for a multi-carrier communication mode.

The apparatus may be further configured to transmit the MSD value(s) to a network.

The test mode may be a factory test mode which is disabled when the apparatus either leaves the factory or is operative in the field.

The apparatus may be further configured to cooperate with an external test computer to perform the radiated performance test. Where this is the case, the apparatus may be further configured to receive from the external test computer information prescribing the conditions of the radiated performance test including at least one of the following: multi-carrier communication mode configurations(s); different permutations of antenna configuration(s) for multi-carrier communication mode configuration(s); transmitter and receiver bandwidth configuration(s); and transmitter power.

The apparatus may be a user equipment.

The apparatus may comprise at least one processor; and at least one memory storing instructions that, when executed by the at least one processor, cause the performance of the apparatus.

According to a second example embodiment, a method is provided comprising: entering a test mode; and determining a maximum sensitivity degradation, MSD, value for a multi-carrier communication mode supported by the apparatus, wherein the MSD value is determined according to a radiated performance test.

The MSD value may be determined when antenna(s) associated with the corresponding multi-carrier communication mode were in an active state during the test mode according to the radiated performance test.

The MSD value may be determined when a transmitter of the apparatus operates at a maximum output power in an environment isolated from any network, wherein the apparatus is in a state that is not configured or controlled by the network.

The MSD value may also be determined when a transmitter of the apparatus operates at maximum bandwidth.

The MSD value may be determined based on a measurement of a received signal strength indication, RSSI, value compared to a noise level.

Multiple MSD values for corresponding multi-carrier communication modes supported by the apparatus may be determined, including for different permutations of antenna configurations for otherwise the same multi-carrier communication mode.

Also, multiple MSD values may be determined for the same multi-carrier communication mode including one determined according to the radiated performance test and at least another not determined according to the radiated performance test.

The method may further comprise storing the MSD value(s) in non-transient storage of the apparatus. Where this is the case, the method may further comprise selecting, using the stored MSD value(s), a multi-carrier communication mode or an antenna configuration for a multi-carrier communication mode.

The method may further comprise transmitting the MSD value(s) to a network.

The test mode may be a factory test mode which is disabled when the apparatus either leaves the factory or is operative in the field.

The method may further comprise cooperating with an external test computer to perform the radiated performance test. Where this is the case, the method may further comprise receiving from the external test computer information prescribing the conditions of the radiated performance test including at least one of the following: multi-carrier communication mode configurations(s); different permutations of antenna configuration(s) for multi-carrier communication mode configuration(s); transmitter and receiver bandwidth configuration(s); and transmitter power.

The method may be implemented with user equipment.

The method may be performed by apparatus comprising at least one processor; and at least one memory storing instructions that, when executed by the at least one processor, cause the performance of the apparatus.

According to a third example embodiment, apparatus comprises: circuitry configured to enter a test mode; and circuitry configured to determine a maximum sensitivity degradation, MSD, value for a multi-carrier communication mode supported by the apparatus, wherein the MSD value is determined according to a radiated performance test.

According to a fourth example embodiment, a non-transitory computer readable medium comprises program instructions that, when executed by an apparatus, cause the apparatus to perform at least the following: entering a test mode; and determining a maximum sensitivity degradation, MSD, value for a multi-carrier communication mode supported by the apparatus, wherein the MSD value is determined according to a radiated performance test.

According to a fifth example embodiment, a computer program is provided comprising instructions, which, when executed by an apparatus, cause the apparatus at least to perform: entering a test mode; and determining a maximum sensitivity degradation, MSD, value for a multi-carrier communication mode supported by the apparatus, wherein the MSD value is determined according to a radiated performance test.

According to some aspects, there is provided the subject matter of the independent claims. Some further aspects are defined in the dependent claims

### BRIEF DESCRIPTION OF THE DRAWINGS

Example embodiments will now be described with reference to the accompanying figures in which:

FIG. 1 illustrates an example embodiment of a factory setup for MSD determination;

FIG. 2 illustrates an example embodiment of tabulated MSD data;

FIG. 3 illustrates an example embodiment of a factory method for MSD determination;

FIG. 4 illustrates an example embodiment of signalling between UE and a Network;

FIG. 5 illustrates a further example embodiment of a factory method for MSD determination;

FIG. 6 illustrates an example embodiment of a UE method;

FIG. 7 illustrates an example embodiment of a network method; and

FIG. 8 is a simplified block diagram illustrating a device that is suitable for implementing example embodiments of the present disclosure.

### DETAILED DESCRIPTION OF EMBODIMENTS

The principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Carrier Aggregation (CA) allows UE to transmit and receive data on multiple component carriers (CCs) at the same time, enabling UE to utilize all available spectrum resources. For example, with 3GPP, in NR, there can be up to 32 CCs aggregated for UE. Each of the CCs can belong to different technologies, e.g. Frequency Division Duplexing (FDD) and Time Division Duplexing (TDD), can belong to different bands, and have different numerologies. The CCs in CA can be either co-located or non-co-located.

Dual Connectivity (DC) allows a UE to transmit and receive data on multiple component carriers from two cell groups (CG) via master node (MN) and secondary node (SN). With Evolved UMTS Terrestrial Radio Access (E-UTRA) Dual Connectivity (EN-DC), a UE can be connected to both Long-Term Evolution (LTE) E-UTRA and 5G NR nodes. The Core Network (CN) is either LTE Evolved Packet Core (EPC) or 5G Core. This was later expanded so that both cells can belong to 5G NR, in which case the CN is exclusively 5G Core. These various options came under the general term Multi-Radio Dual Connectivity (MR-DC). MR-DC is a generalization of Intra-E-UTRA Dual Connectivity. MR-DC can offer a UE more resources for higher throughput. More commonly, it helps operators improve mobility robustness and handovers in macro/micro-cell deployments. It can also aid in migrating networks from 4G to 5G. 5G-New Radio Dual Connectivity (NR-DC) is a 5G connectivity option where one 5G user equipment (UE) connects to the 5G network via both a MN (Master Node) and a SN (Secondary Node). The UE serving cells in MN define the Master Cell Group (MCG), whereas the UE serving cells in SN define the Secondary Cell Group (SCG). DC allows a UE to transmit and receive data on multiple component carriers from two cell groups via a master node (MN) and a secondary node (SN).

When a UE is operated with more than one transceiver active at different spectrum allocations in CA or DC, the UE radio hardware may cause self-interference. Transmitter spectrum content, harmonic response, or harmonic products can create interference inside an active receive band of the same UE. The coupling of the transmitted signal to the receiver happens through circuit boards (i.e. wired) and through antennas (i.e. wireless), and makes the impact of interference UE design dependent.

Currently, in 5G NR, when UE connects to a network for the first time, if the UE is capable of multi-connectivity (CA/DC), the UE can be configured to operate in multi-connectivity mode. Some of the configurations involve static configuration for the resources for the UE. To address operator concerns that a UE's self-interference performance in any given multi-carrier configurations might deviate from agreed specifications, a metric indicating a UE's self-interference performance is used. This metric, maximum sensitivity degradation (MSD), can allows a UE to inform a network of an improved MSD performance relative to the specifications, including in respect of RX victim, TX aggressor(s), MSD type, power class, and MSD class. For example, as shown in the following message format:

LowerMSD-r18 ::= SEQUENCE {

| | |
|---|---|
| aggressorband1-r18 | FreqBandIndicatorNR OPTIONAL, |
| aggressorband2-r18 | FreqBandIndicatorNR OPTIONAL, |
| msdType-r18 | ENUMERATED {harmonic, harmonic mixing, cross band |

isolation, IMD2, IMD3, IMD4, IMD5,ALL} OPTIONAL,

| | |
|---|---|
| msdPowerClass-r18 | ENUMERATED {pc1dot5, pc2, pc3} OPTIONAL, |
| msdClass-r18 | ENUMERATED { classI, classII, classIII, classIV, classV, |
| classVI, classVII, classVIII} | OPTIONAL |

}

The MSD value can be found in the msdClass as shown in Table 1 below, where a step size of at least 3 dB is defined:

TABLE 1
Lower-MSD Capability Classes

| Lower-MSD | | |
|---|---|---|
| capability | Maximum allowed actual | |
| class | MSD (i.e. Threshold) | Remark |
| I | 0 dB | Actual MSD ≤ 0 dB |
| II | 3 dB | Actual MSD ≤ 3 dB |
| III | 6 dB | Actual MSD ≤ 6 dB |
| IV | 9 dB | Actual MSD ≤ 9 dB |
| V | 12 dB | Actual MSD ≤ |
| | | 12 dB |
| VI | 15 dB | Actual MSD ≤ |
| | | 15 dB |
| VII | 18 dB | Actual MSD ≤ |
| | | 18 dB |
| VIII | 22 dB | Actual MSD ≤ |
| | | 22 dB |

There are different types of sources in the UE that lead to self-interference, but they may be regarded as belonging to two different groups. Those where only one UL component carrier is used in a band combination and those that have two uplink component carriers as captured in Table 2 also showing the relations. UL2/DL1 means the second harmonic (2) of the uplink can match the fundamental (1) of the downlink:

TABLE 2
MSD types and combination causing self-interference.

| 1 UL | Relation |
|---|---|
| UL Harmonic | UL2/DL1 |
| | UL3/DL1 |
| | UL4/DL1 |
| | UL5/DL1 |
| Harmonic | UL1/DL2 |
| mixing | UL1/DL3 |
| | UL1/DL4 |
| | UL1/DL5 |
| | UL2/DL3 |
| | UL3/DL4 |
| | UL4/DL3 |
| Cross band | UL1/DL1 |

| 2UL | Relation bands A & B |
|---|---|
| IMD2 | UL1A − UL1B |
| | UL1B − UL1A |
| | UL1A + UL1B |
| IMD3 | UL2A − UL1B |
| | UL2B − UL1A |
| | UL2A + UL1B |
| | UL2B + UL1A |
| IMD4 | 3A/B − 1A/B, 3A/B + 1A/B, 2A/B − 2A/B, |
| | 2A/B + 2A/B |
| | combinations |
| IMD5 | 3A/B − 2A/B, 3A/B + 2A/B, 4A/B − 1A/B, |
| | 4A/B + 1A/B |
| | combinations |

UL harmonics may cause self-interference in the other DL component carrier since the harmonic of the uplink falls inside the other DL component carrier bandwidth at the fundamental carrier frequency of the downlink band.

Harmonic mixing may cause self-interference when a combination of the UL fundamental/harmonic coincides with the DL harmonic of the other DL component.

Cross band is an expression of self-interference when the output spectrum of the UL component carrier falls inside the DL component carrier bandwidth. This can be considered as adjacent channel leakage of the transmitter, where the leakage depends on the non-linear behavior of the power amplifier.

Intermodulation Distortion (IMD) occurs when two UL component carriers intermodulation (mixes) and the product of the mixing of the UL component carriers fall inside the receiver band of one or the other DL component carrier bandwidth at the fundamental carrier frequency of the downlink band. Special cases of IMD (non-contiguous ULCA and triple beat) belong in this category as well.

Conventionally, UE provided MSD values are determined by factory analysis of a representative sample of UE of the same type where the analysis is conducted with the UE antenna isolated to be in a conducted state, i.e. inactive. Current 3GPP measurement procedure of MSD follows 3GPP TS 38.521 and, in particular, there is a specific connection requirement in respect of antenna isolation when determining MSD as shown in 3GPP TS 38.508-1 [5] Annex A, Figure A.3.1.1.3 for TE diagram and section A.3.2 for UE diagram. With this connection requirement, when each SS NR/LTE connects through a RX and TX, it will depend on the routing of the carriers to the connection pin of the antennas for conducted measurements. If these pins don't have a combined relation of all signals in the CA/DC case, then there's no path in this setup that allows an approximation of the antenna isolation. As such, 3GPP procedure and the conformance requirements for MSD will never be aligned with the actual UE antenna isolation performances. Since MSD parameter LowerMSD must be proven under test, UE vendors must determine the msdClass in a test conducted to determine the actual performance in the conducted state. This determines the LowerMSD capability value of the msdClass and is not the same as the performance in the radiated (actual used in network) state.

Currently, for UE static reporting of MSD, a UE implements a table of all MSD outcomes about which of MSD is the worst for the given configuration granted. An example is portion 20 of the table shown in FIG. 2. The UE uses configuration information to traverse the table and identify among all relevant MSD types the worst case that is applicable in the current configuration. It must have the channel information and allocation, for distinguishing between the MSD types, as they are often not present simultaneously for a CA combination. Only through the frequencies assigned to the component carriers will the UE know what is relevant.

A standardized message format using MAC CE for faster exchange of MSD values can be used instead of an RRC based approach. The MAC CE format may replace the need to exchange all MSD and CA configuration data in the UE capability enquiry by allowing the UE to only transfer the relevant MSD information of the CA in the MAC CE to reduce overhead.

MSD refers to the specified sensitivity degradation a UE is allowed to have in DL bands in CA/DC band combinations, where UE self-interference from uplink falls into its active DL band. The specified MSD value is a static value per band combination, hence the gNB will have to assume that this value is always present, and if this CA configuration is used, the gNB may have to adapt its UL or DL transmissions according to this MSD value for example; reducing MCS, increasing power, avoiding that the UE will have to make a UL transmission while simultaneously receiving in DL, or completely avoiding to utilize this CA configuration. MSD also occurs with a single UL CC, and the number of affected bands gets worse with UL CA. Conventional, an MSD value would be the measured by receiving a reference signal in interference conditions, typically 1 dB SNR.

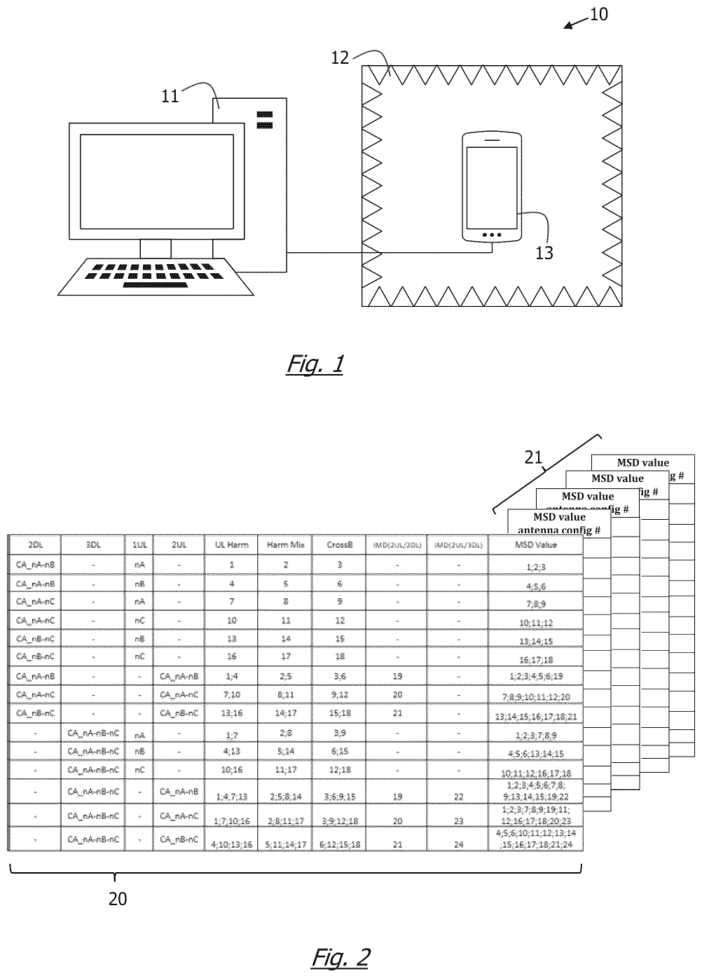

FIG. 1 illustrates an example embodiment of a factory setup 10 for MSD determination. Under the control of a test computer 11 and in a shielded environment 12 to avoid unwanted signal distortion on air, a mobile telephone 13 is provided—the device under test (DUT). Although a mobile telephone, for example a smart phone, is illustrated, any UE could be similarly tested such as tablets, computers, smart watch, or any hand-held, portable, wearable devices, etc.

The mobile telephone 13 is able to determine self-interference in RX bands with active TX signal on the antenna(s) for corresponding CA/DC band combinations supported by the telephone. From this, corresponding radiated MSD (rMSD) levels can be determined. I.e. the setup 10 can account for the effect of antenna isolation, identifying the non-conducted/rMSD performance and not the conducted MSD capability signalled with the conventional msdClass.

As shown in FIG. 2, the MSD factory setup 10 will yield data which can be tabulated in a conventional manner (table portion 20 as discussed above), but with the added rMSD values in portion 21 charactering the radiated performance of telephone 13 for corresponding CA/DC band combinations.

Table 3 below shows interference for various NR CA band combination examples (CA_nX-nY) and NR Rx band (nZ) combinations:

TABLE 3
Interference for various NR CA band combinations
(CA_nX-nY) and NR Rx band (nZ) combinations

| | | | | | IMD | IMD |
|---|---|---|---|---|---|---|
| CA_nX-nY | nZ | UH | HM | CBI | Order | NC ULCA |
| CA_n1-n3 | n1 | | | | IMD3 same | |
| CA_n1-n3 | n3 | | | 1, >2 | | |
| CA_n1-n8 | n1 | | | | IMD4 | |
| CA_n1-n28 | n1 | UL3 | | | | |
| CA_n1-n38 | n1 | | | >2 | | |
| CA_n1-n38 | n38 | | | >2 | | |
| CA_n1-n40 | n1 | | | >2 | | |
| CA_n1-n40 | n40 | | | >2 | | |
| CA_n1-n41 | n41 | | | >2 | | |
| CA_n1-n46 | n1 | | | | IMD5 | |
| CA_n1-n77 | n1 | | | | IMD2 | IMD5 diff |
| CA_n1-n77 | n77 | UL2 | | | | |
| CA_n1-n78 | n1 | | | | IMD4 | IMD7 |
| CA_n1- | n1 | | UL1/DL3 | | IMD3 diff | |
| n102 | | | | | | |
| CA_n1- | n105 | | UL1/DL3 | | IMD3 diff | |
| n105 | | | | | | |

In table 3, interference information includes Uplink Harmonic (UH), Harmonic Mixing (MH) and Cross Band Interference (CBI), Intermodulation Distortion (IMD) Order and IMD Network Control (NC) Uplink Carrier Aggregation (ULCA). Note, tables 2 and 3 are examples relating to 2×CA band combinations and the type of interference listed. In practice, for a real device, those tables out to reflect the supported CA combinations for the specific UE. The table scales with the amount of supported uplink antenna

One or more of the following advantages may accrue using rMSD for corresponding CA/DC band combinations. First, the rMSD values will reflect the antenna(s) characteristics of the actual DUT whereas conventional MSD values are based on conducted antenna(s) which are inactive. Also, conventional MSD values are based on a value determined by analysis of a representative samples of devices of the same type since conventional MSD values are determined on devices that are modified to provide specific connection requirements in respect of antenna isolation as discussed above. With the setup 10 above, unique rMSD values are determined which are specific to the actual DUT), and which can then be used in the field. This avoids the effect of variation due to manufacturing imperfections and variation within accepted manufacturing tolerances. Secondly, with the setup 10 above, the determination of the rMSD value can be relatively straight forward with no or little external equipment required, and executed as fast as the UE can reconfigure the radio and measure the receiver power of a victim band.

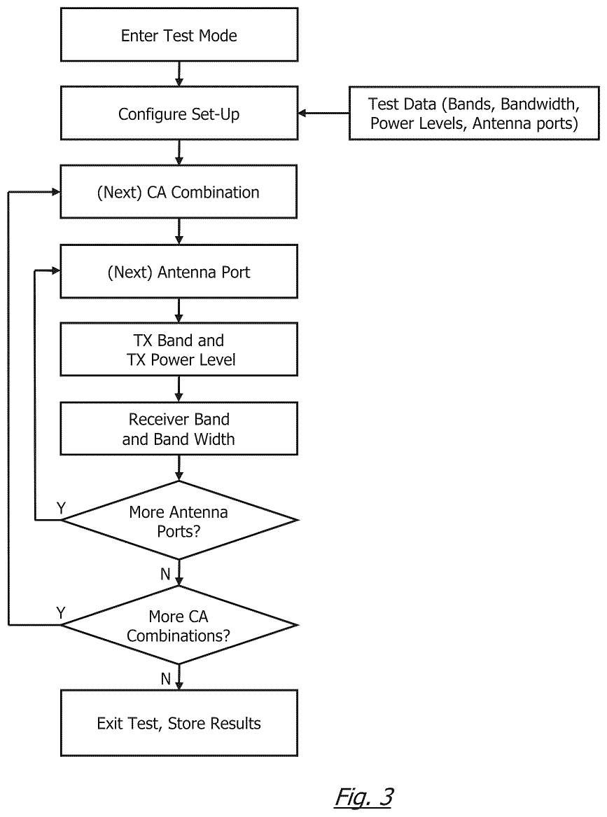

FIG. 3 illustrates an example embodiment of a factory method for rMSD determination. In this method, mobile telephone 13 is placed in a dedicated test mode to avoid normal NR operation. Test computer 11 provides the mobile telephone 13, i.e. the DUT, with test data including a test list of CA/DC band combinations, receiver bands, BW configuration, antenna ports and TX power levels to be tested. This test data is used to configure the mobile telephone 13 for test. The test is executed in the mobile telephone whereby all CA/DC combinations for all available antenna configurations are cycled through and the resulting interference levels are measured by the NR receiver. As the interference signal cannot be decoded, the measurement can be done as RSSI measurement and the measured RSSI level can be compared to the noise floor for the rMSD level calculation. The results are tabulated in a 3D calibrated rMSD table as illustrated in FIG. 2. When tested, the tabulated data is stored and, optionally, provided to the test computer 11.

The extent of test computer 11 involvement may vary. It is possible that the test scheduling and mobile telephone 13 configuration for the various CA/DC band combinations could be wholly under the control of the test computer. Alternatively, the test computer may simply initiate a test mode of the mobile telephone for doing the same. Conceivably, the mobile telephone may be able to determine the rMSD value for various CA/DC band combinations in a wholly standalone configuration.

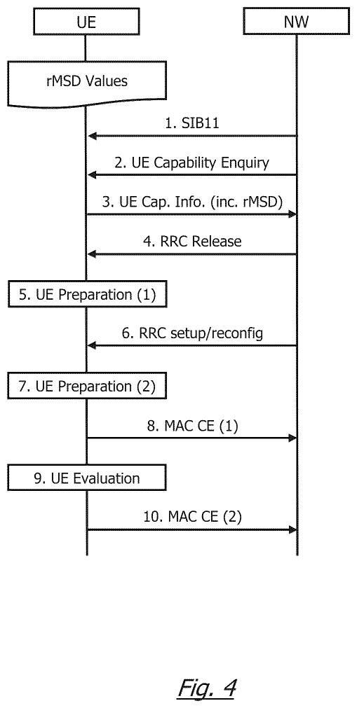

FIG. 4 illustrates an example embodiment of UE-network (NW) signalling in the field where UE has rMSD values for all available CA/DC band combinations supported by the UE stored in file. Such rMSD values, as mentioned above, can be signalled by the UE to NW to inform the NW of an improved MSD performance relative to the specifications, including RX victim, TX aggressor(s), MSD type, power class, and a (new) MSD class table that maps the “radiated” MSD levels for each enumerated class and that will include affected CA/DC combinations.
Step 1. As is conventional, the NW transmits to the UE a system information block (SIB) including channel range per band and a list of potential CA combinations.
Step 2. NW transmits to the UE a ‘UE Capability Enquiry’.
Step 3. In response, the UE transmits to NW ‘UE Capability Enquiry Information’ including an MSD class table that contained the rMSD levels. Extension to a conventional UE Capability Information message may be defined by a new structure of LowerMSD-r20 and introduced into RRC message UECapabilityInformation as follows (enhancements bold & underlined):

LowerMSD-r20 ::= SEQUENCE {

| | | |
|---|---|---|
| aggressorband1-r20 | FreqBandIndicatorNR | OPTIONAL, |
| aggressorband2-r20 | FreqBandIndicatorNR | OPTIONAL, |

| | |
|---|---|
| msdType-r20 | ENUMERATED {harmonic, harmonic mixing, cross band |

isolation, IMD2, IMD3, IMD4, IMD5,ALL} OPTIONAL,

| | | |
|---|---|---|
| msdPowerClass-r20 | ENUMERATED {pc1dot5, pc2, pc3} | OPTIONAL, |

| | |
|---|---|
| msdClassCalibrated-r20 | ENUMERATED { classI, classII, classIII, |

classIV, classV, classVI, classVII, classVIII, classIX, classx, classXI,

| | |
|---|---|
| classXII, classXIII, classXIV, classXV , classXVI} | OPTIONAL |

}
RF-Parameters ::= SEQUENCE {

| | |
|---|---|
| supportedBandListNR | SEQUENCE (SIZE (1..maxBands)) OF BandNR, |

supportedBandCombinationList BandCombinationList OPTIONAL,

| | | |
|---|---|---|
| appliedFreqBandListFilter | FreqBandList | OPTIONAL, |

```
  ...,
  ...,
[[
lowerMSD-r20 SEQUENCE (SIZE (1..maxLowerMSD-r20)) OF LowerMSD-
r20 OPTIONAL
  ]]
  ...
}
```

The rMSD values can be found in an updated (as compared to table 1 above) LowerMSD Capability Classes as shown in table 5 below:

TABLE 5
Revised Lower-MSD Capability Classes

| Lower-MSD | Maximum allowed actual | |
|---|---|---|
| capability | (radiated) | |
| class | MSD (i.e. Threshold) | Remark |
| I | 0 dB | Actual MSD ≤ 0 dB |
| II | 1 dB | Actual MSD ≤ 1 dB |
| III | 2 dB | Actual MSD ≤ 2 dB |
| IV | 3 dB | Actual MSD ≤ 3 dB |
| V | 4 dB | Actual MSD ≤ 4 dB |
| VI | 5 dB | Actual MSD ≤ 5 dB |
| VII | 6 dB | Actual MSD ≤ 6 dB |
| VIII | 7 dB | Actual MSD ≤ 7 dB |
| IX | 8 dB | Actual MSD ≤ 8 |
| | | dB |
| X | 9 dB | Actual MSD ≤ 9 |
| | | dB |
| XI | 10 dB | Actual MSD ≤ 10 |
| | | dB |
| XII | 11 dB | Actual MSD ≤ 11 |
| | | dB |
| XIII | 12 dB | Actual MSD ≤ 12 |
| | | dB |
| XIV | 13 dB | Actual MSD ≤ 13 |
| | | dB |
| XV | 14 dB | Actual MSD ≤ 14 |
| | | dB |
| XVI | 15 dB | Actual MSD ≤ 15 |
| | | dB |

Note that the capability exchange will only be applicable for one uplink antenna configuration, which will be selected as the worst among all uplink antennas, to ensure compliant data despite any uplink antenna selection. It is not possible to exchange data for every uplink antenna configuration, since only the UE knows the exact antenna in use, and the network has no information of UE physical antenna choice.
Step 4. RRC release.
Step 5. UE preparation (1): The UE can prepare MSD values for future use based on the information gathered.
Step 6. RRC Setup/Reconfiguration.
Step 7. UE preparation (2): Immediately after established RRC connected mode or at reconfigurations, the UE can evaluate whether the MSD performance is better than specifications and the values reported in the UE Capability Information. If so, the new value can be reported as a MAC CE.

In respect of UE antenna selection, a UE can be limited to signal only one MSD value (not MSD for every available/potential uplink antenna). If the UE has determined that one of the uplink antennas may have least path loss, but also largest impact on self-interference, it could be requested by the NW to use that antenna. However, the UE can alter the uplink antenna, to one with more path loss, but less self-interference, since the NW doesn't consider self-interference in the SRS switching procedure and does not take into account that if the UE chooses the antenna with least path loss, it may result in downlink carrier failure.

In respect of runtime updates for the radiated MSD values, to support having different MSD values relative to the uplink antenna choice, optionally there may be extended signalling to indicate if an MSD value is a static radiated value, or a runtime determined MSD value, rather than the exchange of UE capability, that is not allowing flexibility to track the uplink antenna configuration. E.g. with MAC CE messaging.
Step 8. MAC CE (1) which can convey a chosen MSD value, optionally a corresponding indication of how it was determined (e.g. static/runtime), and optionally interference type/source/order.
Step 9. UE Evaluation. Whilst in connected mode, the UE can establish whether the actual channel conditions allows the UE to perform better than previously reported relating to MSD. One reason could be that the interferer only partially overlaps the Rx channel. If so, the UE may determine the uplink antenna(s) impact and whether to follow SRS choice or less self-interference impacted the uplink antenna(s).
Step 10. MAC CE (2) conveying an updated MSD information including the possibility of an alternative MSD value, and ancillary information such as interference type/source/order, whether there is full/part interference overlap, etc.

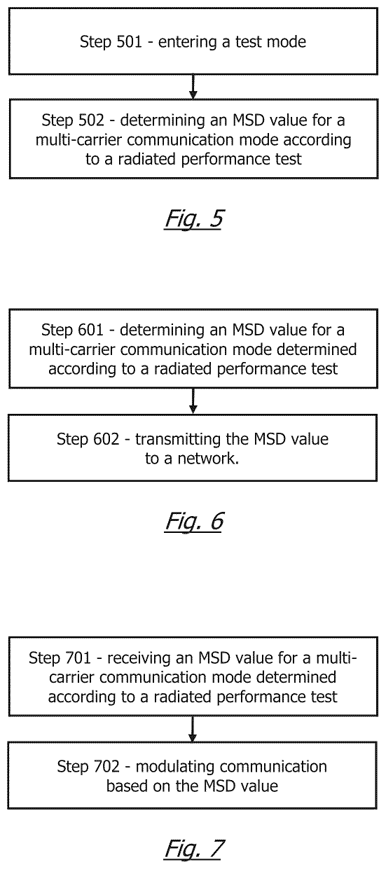

FIG. 5 illustrates a further example embodiment of a factory method for MSD determination comprising entering (step 501) a test mode and determining (step 502) a maximum sensitivity degradation, MSD, value for a multi-carrier communication mode supported by the apparatus, wherein the MSD value is determined according to a radiated performance test.

FIG. 6 illustrates an example embodiment of a UE method comprising determining (step 601) by apparatus an MSD value for a multi-carrier communication mode supported by the apparatus, wherein the MSD value is determined according to a radiated performance test; and transmitting (step 602), by the apparatus, the MSD value to a network.

FIG. 7 illustrates an example embodiment of a network method comprising receiving (step 701) by apparatus an MSD value of UE for a multi-carrier communication mode supported by the UE, wherein the MSD value was determined by the UE according to a radiated performance test, and modulating (step 702) communication with the UE based on the MSD value.

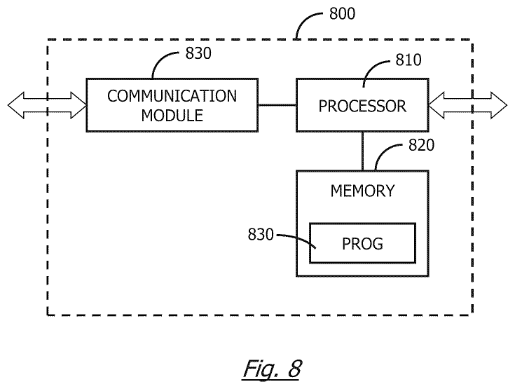

FIG. 8 is a simplified block diagram of a device 800 that is suitable for implementing example embodiments of the present disclosure. The device 800 can be implemented at or as a part of either UE apparatus or cell providing apparatus.

As shown, the device 800 includes a processor 810, a memory 820 coupled to the processor 810, a communication module 830 coupled to the processor 810, and a communication interface (not shown) coupled to the communication module 830. The memory 820 stores at least a program 840. The communication module 830 is for bidirectional communications, for example, via multiple antennas. The communication interface may represent any interface that is necessary for communication.

The program 840 is assumed to include program instructions that, when executed by the associated processor 810, enable the device 800 to operate in accordance with the example embodiments of the present disclosure, as discussed herein with reference to FIGS. 1-8. The example embodiments herein may be implemented by computer software executable by the processor 810 of the device 800, or by hardware, or by a combination of software and hardware. The processor 810 may be configured to implement various example embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods of FIGS. 5 and 6. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Various example embodiments of the techniques have been described. In addition to or as an alternative to the above, the following examples are described. The features described in any of the following examples may be utilized with any of the other examples described herein.

### ACRONYMS

BW Bandwidth
CA Carrier Aggregation
CC Component Carrier
DL Downlink
EIRP Effective Isotropic Radiated Power
gNB 5G NodeB
IMD Intermodulation Distortion
MAC Medium Access Control
MAC CE MAC Control Element
MSD Maximum Sensitivity Degradation
NW Network
RRC Radio Resource Control
RSSI Receive Signal Strength Indicator
UE User Equipment
UL Uplink
ULCA Uplink Carrier Aggregation

1. Apparatus comprising at least one processor; and at least one memory storing instructions that, when executed by the at least one processor, cause the apparatus to:
enter a test mode; and
determine a maximum sensitivity degradation, MSD, value for a multi-carrier communication mode supported by the apparatus, wherein the MSD value is determined according to a radiated performance test,
wherein multiple MSD values for corresponding multi-carrier communication modes supported by the apparatus are determined.

2. Apparatus according to claim 1, wherein the MSD value is determined when antenna(s) associated with the corresponding multi-carrier communication mode were in an active state during the test mode according to the radiated performance test.

3. Apparatus according to claim 1, wherein the MSD value is determined when a transmitter of the apparatus operates at a maximum output power in an environment isolated from any network, wherein the apparatus is in a state that is not configured or controlled by the network.

4. Apparatus according to claim 3, wherein the MSD value is determined when a transmitter of the apparatus operates at maximum bandwidth.

5. Apparatus according to claim 1, wherein the MSD value is determined based on a measurement of a received signal strength indication, RSSI, value compared to a noise level.

6. (canceled)

7. Apparatus according to claim 1, wherein the multiple MSD values include those for different permutations of antenna configurations for otherwise the same multi-carrier communication mode.

8. Apparatus according to claim 1, wherein multiple MSD values for the same multi-carrier communication mode are determined including one determined according to the radiated performance test and at least another not determined according to the radiated performance test.

9. Apparatus according to claim 1, and further configured to store the MSD value(s) in non-transient storage of the apparatus.

10. Apparatus according to claim 9, further configured to select, using the stored MSD value(s), a multi-carrier communication mode or an antenna configuration for a multi-carrier communication mode.

11. Apparatus according to claim 1, and further configured to transmit the MSD value(s) to a network.

12. Apparatus according to claim 1 wherein the test mode is a factory test mode which is disabled when the apparatus either leaves the factory or is operative in the field.

13. Apparatus according to claim 1, and further configured to cooperate with an external test computer to perform the radiated performance test.

14. Apparatus according to claim 13, and further configured to receive from the external test computer information prescribing the conditions of the radiated performance test including at least one of the following:
multi-carrier communication mode configurations(s);
different permutations of antenna configuration(s) for multi-carrier communication mode configuration(s);
transmitter and receiver bandwidth configuration(s); and
transmitter power.

15. Apparatus according to claim 1, which is a user equipment.

16. (canceled)

17. A method comprising:
entering a test mode; and
determining a maximum sensitivity degradation, MSD, value for a multi-carrier communication mode supported by the apparatus, wherein the MSD value is determined according to a radiated performance test,
wherein multiple MSD values for corresponding multi-carrier communication modes supported by the apparatus are determined.
